(19) United States
(12) Patent Application Publication
(10) Pub. No.: US 2024/0318499 A1
(43) Pub. Date: Sep. 26, 2024

(54) Assembly for use in a window covering, window covering provided with such an assembly, method for assembling such a window covering and fastening element described as part of the assembly

(71) Applicant: Coulisse B.V., Enter (NL)

(72) Inventor: Wouter Hendriks, Enschede (NL)

(73) Assignee: Coulisse B.V., Enter (NL)

(21) Appl. No.: 18/627,501

(22) Filed: Apr. 5, 2024

Related U.S. Application Data
(62) Division of application No. 17/305,939, filed on Jul. 16, 2021.

(30) Foreign Application Priority Data
Jul. 17, 2020 (NL) 2026090

(51) Int. Cl. E06B 9/307; E06B 9/28; E06B 9/32

(52) U.S. Cl. CPC E06B 9/307; E06B 9/28; E06B 9/32

(57) ABSTRACT

The invention relates to an assembly of a tilt control cord (106) and a fastening element (1) for fastening to a slat (102A) of a window covering. The fastening element has an elongate body with a length corresponding to the width of the slat. The fastening element includes second fastening means for attaching the ends of the tilt control cord.

The invention also relates to a window covering having a cord spool (104), wherein the tilt control cord (106) is wrapped around the cord spool (104) and extends to the top slat (102A) on which the fastening element (1) is attached.

The invention also relates to a method of assembling the window covering.

### BACKGROUND

This application incorporates by reference Dutch patent application number NL2026090, filed Jul. 17, 2020, and European patent application number EP21183732, filed Jul. 5, 2021, and U.S. patent application Ser. No. 17/305,939, filed Jul. 16, 2021, all of which are hereby incorporated herein by reference for all purposes.

The present invention relates to an assembly for use in a window covering, said window covering comprising ladder tapes, slats and an operating mechanism provided with a cord spool, wherein the assembly comprises a fastening element for fastening to a slat of the window covering, wherein the fastening element has an elongate body with a length corresponding to at least the width of the slat, wherein the body is provided with first fastening means for fastening to the slat.

Such a fastening element is known per se in various variants in the relevant field for detachably fastening one of the horizontal slats of a blind to a ladder cord bridge. In a blind with ladder tape, the tilting of the slats in the ladder tapes can also take place with ladder cords hidden from view by the ladder tapes.

The object of the present invention is to adapt the known fastening element and thereby provide an operating mechanism for tilting the slats in a venetian blind with ladder tapes without the use of ladder cords.

### SUMMARY OF THE INVENTION

In order to achieve this object the assembly according to the present invention further comprises a tilt control cord adapted to be wrapped around the cord spool when in use such that the ends of the tilt control cord extend to the slat to which the fastening element is to be fastened, wherein the assembly includes second fastening means for fastening the ends of the tilt control cord to the fastening element.

In a venetian blind with ladder tapes and ladder cords, a cord spool is already present for raising and lowering the lift cords and for tilting the ladder cords, which cord spool is usually provided with a V-shaped groove in which the ladder cord can be received clampingly. By using the assembly with the fastening element according to the present invention, the tilt control cord can be wrapped around the cord spool already present and fastened to one of the slats. Subsequently, a package of slats comprising slats and ladder tapes can simply be suspended from the relevant slat, for instance by having the relevant slat run at least partly under a ladder tape bridge. The use of ladder cords in a venetian blind with ladder tapes is then no longer necessary. This has the additional advantage that the assembly of the slat package on the head rail of the blind is much simpler and can therefore be carried out faster and without tools.

An example of a fastening element known per se is described in US2015/211292. In the known fastening element, the end of a ladder cord is clampingly received between the fastening element and the slat to which the fastening element is mounted. This clamping makes the known fastening element unsuitable for carrying the load of an entire package of slats.

Another example of a fastening element known per se is described in U.S. Pat. No. 3,916,973. Described herein is an exterior sunblind with several fastening elements, each of which functions as a connecting bridge for the lift cords.

In a general exemplary embodiment of the fastening element according to the present invention, the second fastening means are arranged on the side of the elongate body of the fastening element facing away from the slat. Preferably, the fastening element is fastened against the underside of the slat and is hidden from view as much as possible.

In a first exemplary embodiment of the assembly according to the present invention, the second fastening means comprise two bridges, each having a tilt control cord slot, wherein a space is provided between each bridge and the elongate body, and wherein the ends of the tilt control cord are provided with a boss such as a knot or a bead, wherein the bosses are intended to be accommodated in the spaces. The tilt control cord can be hooked into the fastening element in a simple manner.

In a second exemplary embodiment of the system according to the present invention, the second fastening means comprise first and second cooperating connecting means, wherein the first connecting means are arranged on the elongate body of the fastening element and wherein the second connecting means are arranged at the ends of the tilt control cord. Various connecting means are suitable, such as press studs, hooks and eyes, to facilitate attachment of the tilt control cord to the fastening element.

In a third exemplary embodiment of the assembly according to the present invention, the fastening element consists of two parts which are releasably connectable and the second fastening means are arranged to fix each part of the fastening element to one of the ends of the tilt control cord. The tilt control cord is herein integrated into the fastening element. The attachment to the slat takes place by connecting the two parts of the fastening element to each other, for example by means of a snap connection.

In a further exemplary embodiment of the assembly according to the present invention, the first fastening means are formed by bent short sides of the body of the fastening element for clamping engagement around the slat.

According to a practical exemplary embodiment of the assembly according to the present invention, the body of the fastening element is provided with a through-hole for lift cords of the window covering.

In an exemplary embodiment, the fastening element comprises plastic.

The present invention also relates to a window covering comprising a head rail, a slat package comprising two or more ladder tapes and a series of slats extending horizontally in the ladder tapes and an operating mechanism for tilting the slats, wherein the operating mechanism comprises a cord spool for positioning in the head rail.

In addition to the known window covering with ladder cords and ladder tapes, an alternative window covering is known in the relevant art using only ladder tapes. This alternative window covering includes a complex spool, which is adapted for tilting the ladder tapes.

It is also an object of the present invention to provide an improved window covering with an alternative operating mechanism for tilting the slats.

The window covering according to the present invention is thereto characterized in that the operating mechanism further comprises an assembly according to the present invention, wherein the tilt control cord is wrapped around the cord spool and extends to one of the slats, preferably the top slat, and wherein the fastening element is releasably fastened to said slat and is connected to the ends of the tilt control cord.

In the window covering of the present invention, the known standard cord spool of the known window covering with ladder cords and ladder tapes can be used for tilting the slats in ladder tapes without the use of ladder cords. A complex adjustment to the spool is not required.

In a first exemplary embodiment of the window covering according to the present invention the cord spool is provided with a groove in which the tilt control cord is clampingly received. Such a groove is usually already present in the standard cord spool so that no adjustments to the cord spool are necessary.

In an exemplary embodiment, the fastening element is fastened against the underside of said slat, so that it is hidden from view.

In an exemplary embodiment, the operating mechanism of the window covering according to the present invention is motorized.

In an exemplary embodiment, the window covering according to the present invention is a venetian blind.

The invention further relates to a method for assembling a window covering according to the invention, whereby the method comprises the following steps:
a) Wrapping the tilt control cord around the cord spool;
b) Fastening the fastening element to a slat;
c) Optionally fastening the tilt control cord to the fastening element;
d) Suspending the slat package on said slat such that the ladder tape bridges extend at least in part over said slat.

The method according to the present invention is considerably simpler and faster to perform than known methods for assembling the known window coverings. In addition, no tools are required.

The invention also relates to a fastening element as described as part of the assembly according to the invention.

### DESCRIPTION OF THE DRAWING

The invention will now be described in more detail with reference to the figures, wherein

FIG. 1 shows a schematic view of a window covering according to the invention;

FIG. 2 shows the window covering of FIG. 1 with parts broken away and shifted;

FIGS. 3A and 3B show a first exemplary embodiment of the fastening element according to the invention from different points of view;

FIGS. 4A and 4B show a second exemplary embodiment of the fastening element according to the invention from different points of view; and

FIG. 5 shows a third exemplary embodiment of the fastening element according to the invention.

### DETAILED DESCRIPTION

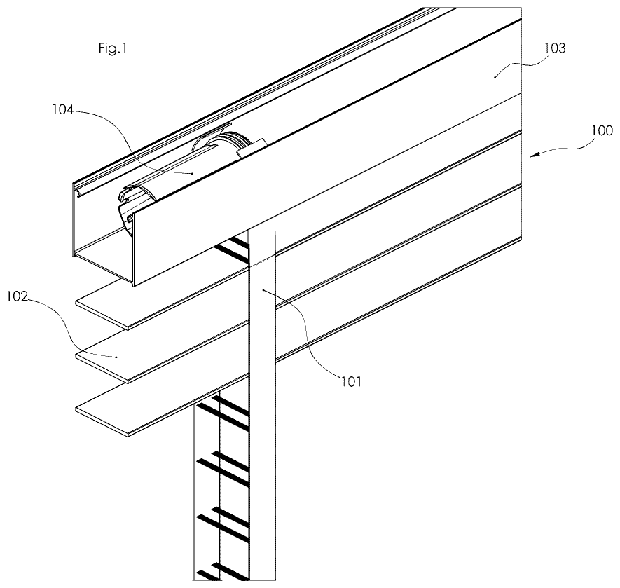

FIG. 1 shows a schematic view of a first exemplary embodiment of a window covering 100 according to the invention. The window covering 100 is a venetian blind having two or more ladder tapes 101, one of which is visible. A series of slats 102 extend horizontally in the ladder tapes 101. The window covering 100 includes a head rail 103, in which is located an operating mechanism for tilting and tilting the slats 102. Only a cord spool 104 of the operating mechanism is shown. The operating mechanism can be either motorized or manual.

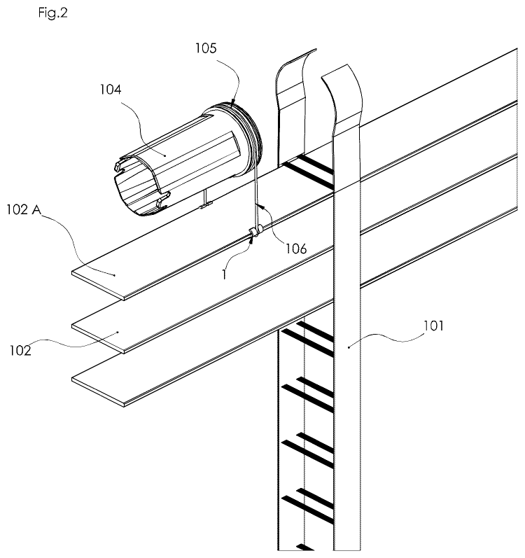

FIG. 2 shows the window covering 100 of FIG. 1 without the head rail 103. Furthermore, in FIG. 2, the cord spool 104 has been shifted out of the ladder tape 101. In the first exemplary embodiment, the cord spool 104 is provided with a groove 105 into which extends a tilt control cord 106 for tilting the slats. Preferably, the groove 105 is V-shaped, such that the tilt control cord 106 is clampingly received therein. The tilt control cord 106 is wrapped around the cord spool 104 and is connected to one of the slats 102, in the first exemplary embodiment to the top slat 102A. The ends of the tilt control cord 106 are fastened to the slat 102A by means of a fastening element 1 according to the invention. The fastening element 1 is preferably fastened against the underside of the slat 102A, but this is not necessary.

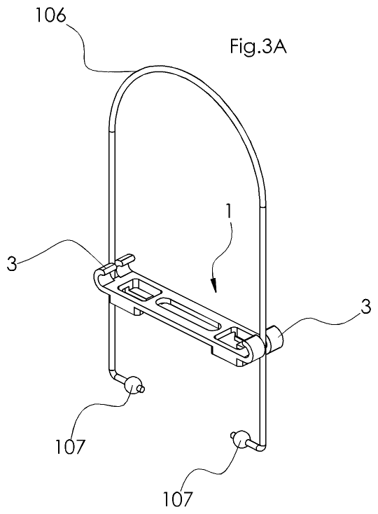

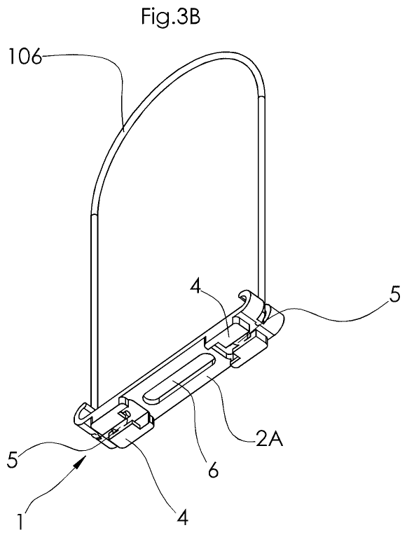

FIGS. 3A, 3B, 4A, 4B and 5 show three variants of an assembly of a fastening element and a tilt control cord according to the invention. The fastening element according to the invention can also referred to as a slat clip.

FIG. 3A and FIG. 3B show a first exemplary embodiment of the fastening element 1 according to the invention schematically in top and bottom view, respectively.

The fastening element 1 has an elongate body 2 with a length corresponding to at least the width of the slat 102A. The body 2 is provided on the short sides with first fastening means 3 for fastening engagement around the slat 102A. In the shown exemplary embodiment the first fastening means are designed as bent ends 3. The bent ends 3 can be designed both rigidly and flexible.

According to the invention, the fastening element 1 is provided on the side 2A of the body 2 which is to be turned away from the slat, with second fastening means 4, 5 for receiving the ends of the tilt control cord 106.

Preferably, the second fastening means are adapted to receive both ends of the tilt control cord 106. In the first exemplary embodiment shown, the second fastening means comprise two bridges 4, each with a slot 5 for the fastening cord, in which a space is left between the bridge 4 and said side 2A that is intended to receive a boss 107 at the end of the cord 106, such as a knot or bead.

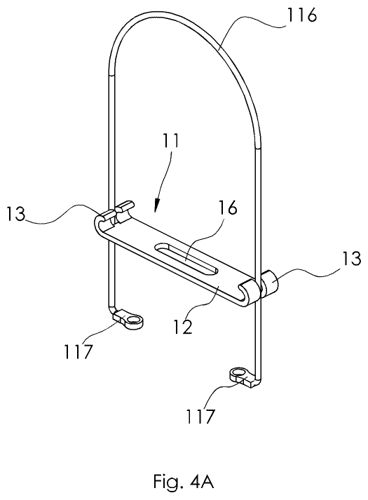

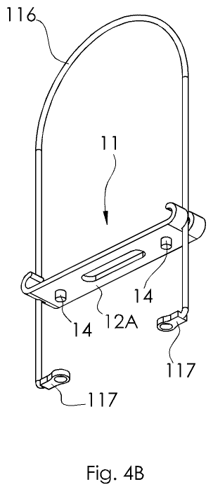

FIG. 4A and FIG. 4B show a second exemplary embodiment of the fastening element 11 according to the invention, schematically in top and bottom view, respectively.

The reference numerals are incremented by the number 10 relative to the reference numerals in the first exemplary embodiment.

The fastening element 11 differs from the fastening element 1 with regard to the second fastening means, which comprise first and second cooperating connecting means 14, 117. The first connecting means 14 are arranged on the elongate body 2. The second connecting means 117 are arranged at the ends of the tilt control cord 116. In the second exemplary embodiment shown, the first connecting means are protrusions 14, which are clampable in openings forming part of the second connecting means 117. Various other cooperating connecting means are suitable as an alternative.

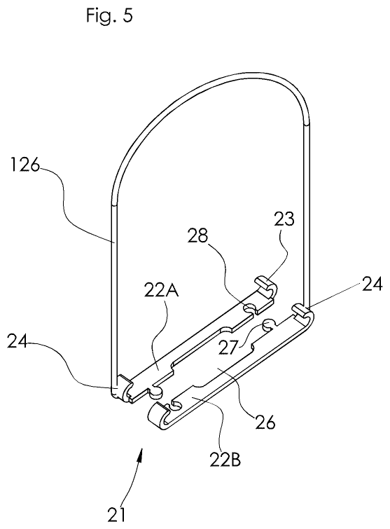

FIG. 5 shows a third exemplary embodiment of the fastening element 21 according to the invention.

The reference numerals are incremented by the numeral 20 relative to the reference numerals in the first exemplary embodiment and by the numeral 10 relative to the reference numerals in the second exemplary embodiment.

The fastening element 21 differs from the fastening element 1 with regard to the second fastening means 24, which integrally connect the tilt control cord 126 to the body 22. The body of the fastening element 21 consists of two parts 22A, 22B which are each fixed to an outer end of the tilt control cord 126. The parts 22A, 22B are releasably connectable by first and second cooperating connecting means. In the third exemplary embodiment shown, the releasable connection is formed by two pairs of cooperating projections 27 and openings 28. The projections 27 and openings 28 have a corresponding shape and fit together like puzzle pieces.

In the third exemplary embodiment shown, the body 22 is longitudinally divided into two parts. It will be clear that the body can also be divided into two parts in other directions, for instance in transverse direction.

The present invention is based on the idea of allowing the slats 102 to tilt along in a ladder tape when only the tilting action of one of the slats, preferably the top slat 102A, is controlled. In the exemplary embodiments shown, rotation of the cord spool 104 will cause the slat 102A to which the fastening element 1, 11, or 21 is mounted to tilt. Subsequently, all slats 102 in the ladder tapes 101 will begin to tilt along.

The cord spool 104 preferably also serves for winding up and unwinding lift cords for the slats 102. The fastening element 1, 11, 21 may be provided for this purpose with a central opening 6, 16, 26 for the lift cords (not shown).

Assembly of the window covering 100 according to the invention takes place by a method comprising the steps below.

In step a), the tilt control cord 106, 116 or 126 is wrapped around the cord spool 104 and received in the groove 105.

In step b) the fastening element 1, 11, 21 is fastened to the slat 102A by means of the first fastening means 3, 13, 23. For the fastening element 21, the two parts 22A, 22B of the body 22 are also connected to each other by means of the cooperating connecting means 27, 28. Step c is not necessary for the fastening element 21.

With the fastening element 1 or 11, steps a) and b) can be performed in any order. Subsequently, in step c) the tilt control cord 106 or 116 should be attached to the fastening element 1 or 11. In the case of the fastening element 1, this is done by hooking the ends 107 in the space under the bridge 4 and inserting the tilt control cord 106 into the slot 5. slide. In the case of the fastening element 11, this takes place by accommodating the protrusions 14 in the openings of the second connecting means 117.

In a separate step d), the package of slats is suspended from said slat 102A such that the ladder tape bridges 101 extend over said slat 102A. The ends of the ladder tapes 101, which project above the slat 102A, can be optionally concealed.

It is noted for the sake of completeness that the invention is of course not limited to the described and shown exemplary embodiments.

The invention extends to any embodiment falling within the scope of protection as defined in the claims and as seen in the light of the foregoing description and accompanying drawings.

1. A window covering, comprising
a head rail;
a slat package comprising two or more ladder tapes and a series of slats extending horizontally in the ladder tapes; and
an operating mechanism, wherein the operating mechanism comprises a cord spool for placement in the head rail, wherein the operating mechanism further comprises a fastening element provided with a tilt control cord, wherein the tilt control cord has a first end and a second end, wherein the slats have a width, wherein the fastening element has an elongate body with a length corresponding to at least the width of the slats, wherein the elongate body is provided with first fastening means that releasably fasten the fastening element to one of the slats, wherein the tilt control cord is wrapped around the cord spool and second fastening means are provided that fasten the first end and the second end of the tilt control cord to the fastening element, whereby the operating mechanism can tilt the slats of the window covering without the use of ladder cords.

2. The window covering according to claim 1, wherein the cord spool is provided with a groove, in which the tilt control cord is clampingly received.

3. The window covering according to claim 1, wherein one of the slats of the slat package is a top slat, wherein the fastening element is fastened to the top slat of the slat package.

4. The window covering according to claim 3, wherein the tilt control cord has a total length of substantially twice the distance from the center of the cord spool to the top slat plus half the circumference of the cord spool.

5. The window covering according to claim 1, wherein the fastening element is fastened against the underside of the slat.

6. The window covering according to claim 1, wherein the elongate body has a side, wherein the second fastening means are arranged on the side of the elongate body of the fastening element facing away from the slat.

7. The window covering according to claim 1, wherein the second fastening means comprise two bridges each having a tilt control cord slot, wherein a space is provided between each bridge and the elongate body, and wherein the first outer end and the second outer end of the tilt control cord are provided with a boss.

8. The window covering according to claim 7, wherein the bosses are knots or beads.

9. The window covering according to claim 7, wherein the bosses are intended to be accommodated in the spaces.

10. The window covering according to claim 1, wherein the second fastening means comprise first and second cooperating connecting means, wherein the first connecting means are arranged on the elongate body of the fastening element and wherein the second connecting means are arranged at the first outer end and at the second outer end of the tilt control cord.

11. The window covering according to claim 1, wherein the fastening element comprises a first part and a second part which are releasably connectable and wherein the second fastening means fix the first part of the fastening element to the first outer end of the tilt control cord and wherein the second fastening means fix the second part of the fastening element to the second outer end of the tilt control cord.

12. The window covering according to claim 1, wherein the elongate body of the fastening element has short sides, wherein the first fastening means are formed by bent ends of the short sides of the elongate body of the fastening element for clamping engagement about the slat.

13. The window covering according to claim 1, wherein the window covering further comprises lift cords and the elongate body of the fastening element is provided with a through-hole for the lift cords.

14. The window covering according to claim 1, wherein the fastening element comprises plastic.

15. The window covering according to claim 1, wherein the operating mechanism is motorized.

16. The window covering according to claim 1, wherein the window covering is a venetian blind.
